(19) United States
(12) Patent Application Publication
(10) Pub. No.: US 2007/0236922 A1
(43) Pub. Date: Oct. 11, 2007

(54) Collapsible illuminated container

(75) Inventors: Kelly C. Sheehan, Mercer Island, WA (US); Michael O. Roser, Bellevue, WA (US)

Correspondence Address: BLACK LOWE & GRAHAM, PLLC, 701 FIFTH AVENUE, SUITE 4800, SEATTLE, WA, 98104, US

(73) Assignee: Garden Works, Inc., Bellevue, WA (US)

(21) Appl. No.: 11/400,504

(22) Filed: Apr. 7, 2006

(51) Int. Cl. F21S 8/00

(52) U.S. Cl. 362/162; 362/154

(57) ABSTRACT

A bucket includes a base and a top defining an aperture approximating a perimeter of the base. A wall formed of a flexible material extends between the base and the top. A helical reinforcing member secures to the wall, the base, and the top and includes multiple windings approximating the perimeter of the base. A conducting element secures to the wall having a substantial portion of the conducting element extending proximate the helical reinforcing member. A light source secures to the wall and is electrically coupled to the conducting element. A power source connects to the conducting element to power the light source. A switch may selectively electrically connect the light source to the power source and may be mounted in a grip secured to the handle.

### FIELD OF THE INVENTION

This invention relates generally to illuminated containers used for trick-or-treating.

### BACKGROUND OF THE INVENTION

Halloween comes once a year. Decorations, costumes, and the like must therefore remain in storage for the rest of the year. One important Halloween accessory that is particularly bulky is the trick-or-treating bucket. Buckets prevent crushing of their contents and always remain open, as opposed to a plastic or fabric bag which must be held open to receive candy. Inasmuch as trick-or-treating takes place at night, many buckets are provided with lights to illuminate a child's path or to improve the child's visibility to motorists. Illuminated buckets are much too expensive to be purchased and then discarded. They must therefore be stored from November 1^{st} to October 31^{st}.

Accordingly, it would be an advancement in the art to provide a trick or treating bucket providing the enhanced safety of illumination, but which is also compactly stored.

### SUMMARY OF THE INVENTION

A bucket includes a base and a top defining an aperture approximating a perimeter of the base. A wall formed of a flexible material extends between the base and the top. A helical reinforcing member secures to the wall, the base, and the top and includes multiple windings approximating the perimeter of the base. A conducting element secures to the wall having a substantial portion of the conducting element extending proximate the helical reinforcing member.

A light source secures to the wall and is electrically coupled to the conducting element. The light source may be secured to the wall by a decorative element secured to the wall. A power source also connects to the conducting element to power the light source. In one embodiment, the power source is embedded in the base. A switch may selectively electrically connect the light source to the power source. In one embodiment, the switch is mounted to a grip secured to a handle pivotally connected to the top. Wires connecting the switch to the light source and power source may extend through a hollow portion of the handle.

### BRIEF DESCRIPTION OF THE DRAWINGS

Preferred and alternative embodiments of the present invention are described in detail below with reference to the following drawings.

FIG. 1 is a perspective view of a collapsible illuminated bucket in accordance with an embodiment of the present invention;

FIG. 2 is a perspective view of a top, base, and reinforcing element suitable for use in the bucket of FIG. 1 in accordance with an embodiment of the present invention;

FIG. 3 is a perspective view of the bucket of FIG. 1 in a collapsed position in accordance with an embodiment of the present invention; and

FIG. 4 is a side cross-sectional view of the wall of the bucket illustrated in FIG. 1 in accordance with an embodiment of the present invention.

### DETAILED DESCRIPTION OF THE PREFERRED EMBODIMENT

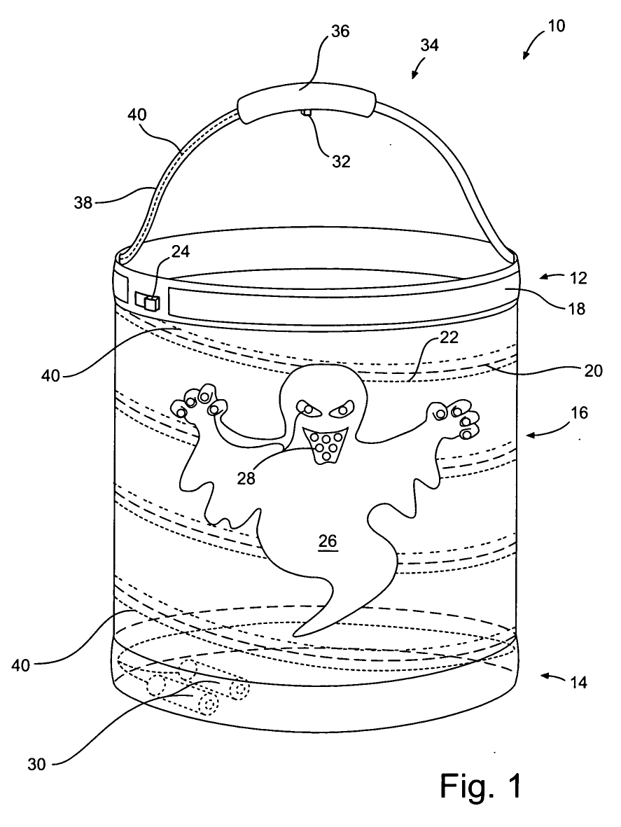

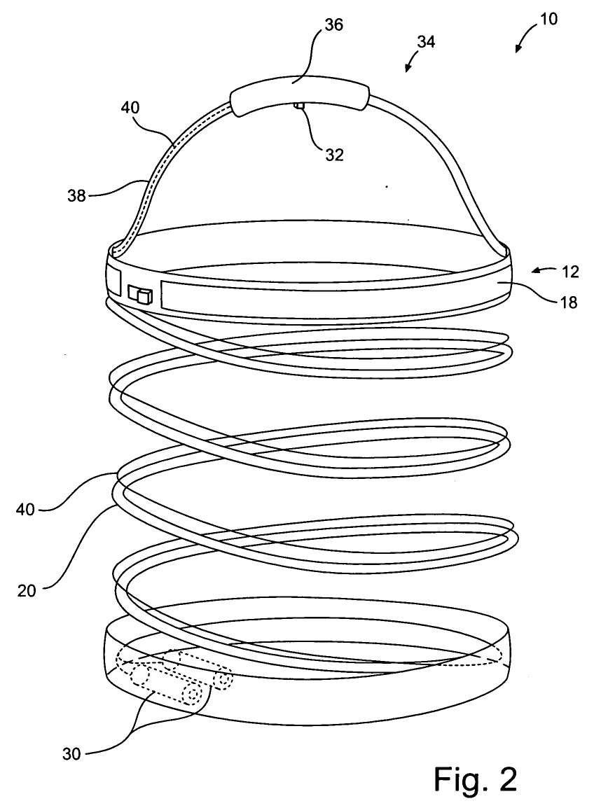

Referring to FIGS. 1 and 2, a bucket 10 includes a top portion 12, a base 14, and a wall 16. The top portion 12 may be embodied as a ring or other structure defining a large aperture serving as an opening for the bucket 10. The opening defined by the top portion 12 typically approximates the perimeter of the base 14, which is circular in the illustrated embodiment. The top 12, base 14, or both, may have reflective tape 18 secured thereto to improve visibility of the bucket 10.

The wall 16 is typically formed of a flexible material, such as fabric or plastic. A reinforcing element 20 secures to the top portion 12 and the base 14 and maintains the shape of the wall 16. The reinforcing element 20 is typically a helix including multiple windings having a shape approximating the perimeter of the base 14. In the illustrated embodiment, the reinforcing element 20 includes circular windings. The reinforcing element 20 is typically formed of resilient material such as steel or rigid plastic. The wall 16 may be formed from two layers of material capturing the reinforcing element 20 there between. Stitching 22 secures the two layers to one another. The stitching 22 may be spirally disposed on the wall 16 such that the reinforcing element 20 extends adjacent the stitching 22 and may be restrained thereby. The stitching 22 may extend above or below the reinforcing element 20. In some embodiments, stitching 22 may include two rows of stitches above and below the reinforcing element 20.

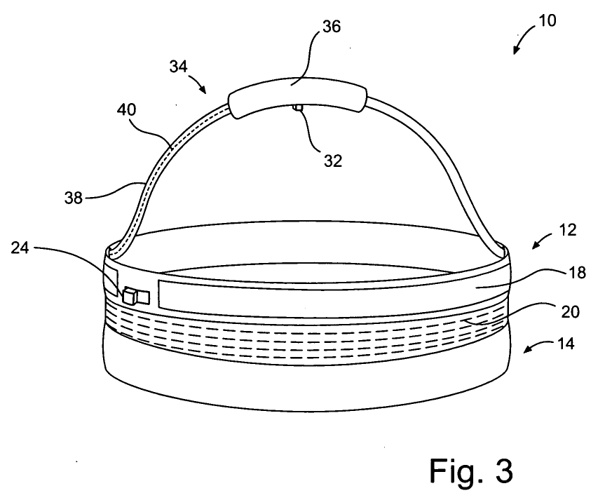

Referring to FIG. 3, while still referring to FIGS. 1 and 2, the bucket 10 may be collapsed as shown in FIG. 3 by pushing the top 12 toward the base 14. A lock 24 may be provided on the top 12 or base 14 and engageable with the other of the base 14 or top 12 to fix the position of the top 12 relative to the base 14 during storage.

Referring again to FIG. 1, a decal 26 secures to the wall 16 of the bucket 10. The decal 26 is preferably made of nylon, felt, or like material. The decal 26 may be secured to the wall 16 by means of stitching, adhesives, or the like. Lights 28 may be retained by the decal 26 to the wall 16. Alternatively, the lights are secured directly to the decal 26 or to the wall 16. The lights 28 may be embodied as light emitting diodes (LED), incandescent light bulbs, fiber optic elements, or other means. A power source 30 for the lights 28 may be embedded within the base 14 or top 12. A switch 32 for controlling the supply of electrical power to the lights 28 may secure within a handle 34 extending across the top 12. In the illustrated embodiment, the switch 32 secures to a grip 36 secured to a tube 38 extending across the top 12 and pivotally securing to the top 12. Wires 40 extend from the switch 32 through the tube 38 and the wall 16 to the lights 28. In a like manner the wires 40 extend from the power source 30 to the lights 28 and switch 32 to form a complete circuit. In one embodiment, the wires 40 extend along the reinforcing element 20. Extension of the wires 40 along the reinforcing element 20 advantageously ensures that the resilience of the reinforcing element 20 will prevent excessive tension on the wires 40.

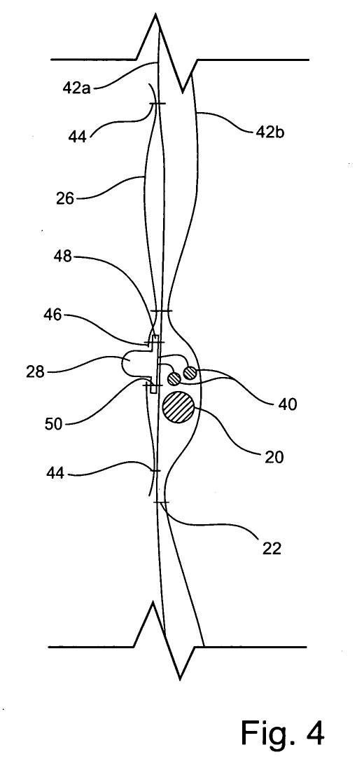

Referring to FIG. 4, the decal 26 secures to an outer layer 42a of the wall 16 by means of stitching 44, or other fastening means. One or more lights 28 extend through apertures 46 in the decal 26. Alternatively, the decal 26 may be provided with transparent or translucent areas through which the lights 28 are visible. The lights 28 may have a base 48 secured thereto to facilitate securement thereof to the bucket 10. In the illustrated embodiment stitching 50 extends through the decal 26, base 48, and outer layer 42a to fasten the light 28 to the bucket 10. In embodiments wherein the decal 26 is adhered to the outer layer 42a by means of an adhesive, the base 48 may secure between the decal 26 and the outer wall 42a.

The wires 40 powering the light 28 may extend through the outer wall 42a into the space between the outer wall 42a and inner wall 42b. The wires 40 may be directed along the reinforcing element 20 to the power source located in the base 14 and to the switch 32 located in the handle 34. Stitching 22 maintains the reinforcing element 20 and wires 40 in a spiral configuration. Stitching 22 may be located on one or both sides of the reinforcing element 20 and wires 40.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A bucket comprising:
a base;
a top defining an aperture approximating a perimeter of the base;
a wall extending between the base and top, the wall comprising a flexible material;
a helical reinforcing member having a first end attached to the base and a second end attached to the top, and extending along the wall from the first end to the second end; and
a light source secured to the wall and electrically coupled to a power source.

2. The bucket of claim 1, wherein the power source is secured to the base.

3. The bucket of claim 1, further comprising a decorative element secured to the wall, the light source being captured between the decorative element and the wall.

4. The bucket of claim 1, wherein the decorative element secures to an outer surface of the wall and has a perimeter, the light source emanating from within the perimeter.

5. The bucket of claim 1, further comprising reflective material attached to at least a portion of the top.

6. The bucket of claim 1, further comprising a handle having first and second ends each pivotally secured to the top.

7. The bucket of claim 6, wherein the handle comprises a switch secured thereto, a conducting member secured to the switch such that the switch is electrically interposed between the light source and the power source.

8. The bucket of claim 7, wherein the handle comprises an interior portion, the conducting member extending through the interior portion.

9. The bucket of claim 7, wherein the wall comprises two substantially coextensive layers, substantial portions of the reinforcing member and conducting member position being positioned between the layers.

10. The bucket of claim 9, further comprising stitching securing the coextensive layers to one another, a substantial portion of the reinforcing member aligned with the stitching.

11. The bucket of claim 1, further comprising a lock selectively engaged with both the top and the bottom to retain the top proximate the bottom.

12. A bucket comprising:
a base;
a top defining an aperture approximating a perimeter of the base;
a wall extending between the base and top, the wall comprising a thin, flexible material;
a means for expanding the wall secured to the base and the top; and
a lighting means secured to the wall and electrically coupled to a power source.

13. The bucket of claim 12, wherein the power source is secured to the base.

14. The bucket of claim 12, further comprising a decorative element secured to the wall, the lighting means being captured between the decorative element and the wall.

15. The bucket of claim 12, wherein the decorative element secures to an outer surface of the wall and has a perimeter, lighting means emanating from within the perimeter.

16. The bucket of claim 12, further comprising a means for reflecting attached to at least a portion of the top.

17. The bucket of claim 12, further comprising a carrying means secured to the top.

18. The bucket of claim 17, wherein a switch secures to the carrying means and a conducting member secures to the switch such that the switch is electrically interposed between the lighting means and the power source.

19. The bucket of claim 18, wherein the carrying means comprises a handle having an interior portion, the conducting member extending through the interior portion.

20. The bucket of claim 19, wherein the wall comprises two substantially coextensive layers, substantial portions of the expanding means and conducting member being positioned between the layers.
